(19) United States
(12) Patent Application Publication
(10) Pub. No.: US 2010/0151339 A1
(43) Pub. Date: Jun. 17, 2010

(54) FUEL CELL SYSTEM AND METHOD FOR REGULATING A FUEL CELL SYSTEM

(76) Inventors: Martin Müller, Sinzit (DE); Andreas Maintz, Baesweiler (DE); Jörg Wilhelm, Duren (DE); Holger Janssen, Julich (DE); Detlef Stolten, Aachen-Walheim (DE)

Correspondence Address: International IP Law Group, P.O. BOX 691927, HOUSTON, TX, 77269-1927, US

(21) Appl. No.: 12/532,441

(22) PCT Filed: Mar. 19, 2008
(86) PCT No.: PCT/EP08/02193

§ 371 Date: Feb. 5, 2010

(30) Foreign Application Priority Data
Mar. 23, 2007 (DE) 10 2007 014 617.7

(51) Int. Cl. H01M 8/04

(52) U.S. Cl. 429/431; 429/428; 429/432

(57) ABSTRACT

There is provided a fuel cell system for mobile applications. An exemplary fuel cell system comprises a fuel cell and a DC/DC transformer that is coupled to the fuel cell and that can be coupled to an energy storage unit. The exemplary fuel cell system also comprises a control and regulation unit connected to the fuel cell and to the DC/DC transformer, the control and regulation unit being adapted to store performance characteristics of a fuel cell that has not aged. The exemplary fuel cell system additionally comprises a performance characteristic regulator associated with the control and regulation unit, the performance characteristic regulator being adapted to receive a value I_{FC,actual} of a current and to receive from the fuel cell a voltage value U_{FC,actual} as well as a value for at least one additional operating variable of the fuel cell system, the performance characteristic regulator being adapted to process the received values I_{FC,actual}, U_{FC,actual} and the value for the operating variable so as to create a control signal, and to relay the control signal to a device for controlling the operating variable.

### CROSS REFERENCE TO RELATED APPLICATIONS

Pursuant to 35 U.S.C. §371, this application is the United States National Stage Application of International Patent Application No. PCT/EP2008/002193, filed on Mar. 19, 2008, the contents of which are incorporated by reference as if set forth in their entirety herein, which claims priority to German (DE) Patent Application No. 102007014617.7, filed Mar. 23, 2007, the contents of which are incorporated by reference as if set forth in their entirety herein.

### BACKGROUND

Fuel cell systems in hybrid systems for mobile applications have to be designed and configured with an eye towards the dynamic requirements of the consumer. As a rule, the basic structure comprises a fuel cell and an energy storage unit. Differences in the configuration of such hybrid systems lie especially in the electrotechnical coupling of the fuel cell and the energy storage unit as well as in the control and regulation of the entire system and especially of the fuel cell.

The prior-art hybrid systems, consisting of a fuel cell and an energy storage unit, can be fundamentally broken down into passive and active hybrid systems. In passive hybrid systems, the fuel cell and the energy storage unit are connected to each other directly in parallel, i.e. they are operated at the same voltage level in every operating state of the overall system. Active systems are characterized by an uncoupling of the fuel cell and the energy storage unit through DC/DC transformers. Hence, as a matter of principle, the distribution of the energy flows to the fuel cell and to the energy storage unit can be influenced, irrespective of the load requirement. One way to control active systems is to employ two-point regulation to keep the state of charge of the energy storage unit between a minimum and a maximum value. In order to keep the state of charge of the energy storage unit between the two limit values, the energy storage unit has to be charged from time to time by the fuel cell. In the known state of the art, this is done in that the fuel cell is operated at its maximum output.

In the case of passive systems, the on-board voltage, i.e. the voltage at the energy storage unit of the entire system is applied to the fuel cell. For this purpose, it is necessary to coordinate the components very precisely with each other. It is not possible to actively operate the fuel cell at another operating point. This entails two problematic aspects:

Under certain circumstances, voltages could occur that damage the fuel cell or lead to premature ageing. Secondly, in case of ageing of the fuel cell, it is not possible to actively influence the fuel cell voltage, for example, in order to retain the output of the fuel cell by lowering the voltage.

In active systems, an independent mode of operation of the fuel cell is possible. However, in the state of the art described above, no attention is paid as to whether the mode of operation has an impact on its ageing nor to how to be able to compensate for this loss in performance of the fuel cell.

### SUMMARY OF THE INVENTION

Exemplary embodiments of the present invention relates to a fuel cell system for mobile applications, comprising a fuel cell and a DC/DC transformer that is coupled to the fuel cell and that can be coupled to an energy storage unit, comprising an active hybrid system with such a fuel cell system as well as with an energy storage unit, and the invention also relates to a method for regulating a fuel cell voltage as well as to a method for regulating the performance characteristics of a fuel cell.

An exemplary embodiment of the present invention relates to the operation of a fuel cell in a dynamically operated and active hybrid system in such a way as to compensate for ageing processes of the fuel cell.

In addition, exemplary embodiments of the present invention relate to a fuel cell system for mobile applications, comprising a fuel cell and a DC/DC transformer that is coupled to the fuel cell and that can be coupled to an energy storage unit, whereby the fuel cell system is characterized in that a control and regulation unit is connected to the fuel cell and to the DC/DC transformer, and this unit receives a controlled variable U_{FC,actual} from the fuel cell, determines a manipulated variable I_{DC/DC,setpoint} on this basis, and relays it to the DC/DC transformer.

In this manner, the possibility exists to influence the operating voltage U_{FC} of the fuel cell.

In an exemplary embodiment of the fuel cell system, the control and regulation unit comprises a performance characteristic regulator which receives from the DC/DC transformer a value of the current manipulated variable I_{FC,actual} and receives from the fuel cell the controlled variable U_{FC,actual} as well as a value for at least one additional operating variable of the fuel cell system, said regulator processes the received values I_{FC,actual}, U_{FC,actual} and the value for the operating variable so as to form a control signal, and then relays the control signal to a device for controlling the operating variable.

In an exemplary embodiment of the fuel cell system, the control and regulation unit comprises a PID controller.

The use of a controller, for example, a PID controller, proves to be especially advantageous when a controlled variable is supposed to adhere to a desired value as precisely as possible. Moreover, it could also be the case that the command variable changes. Then the controller and the actuating element operate continuously. In the case of the fuel cell system according to an exemplary embodiment of the present invention, the variable U_{FC,setpoint} constitutes a command variable that can change, as is described below. Linear controllers such as, for example, PID controllers, have proven their worth in such applications. In actual practice, PID controllers are usually not individual devices but rather compact controllers. The structure of such a controller is a parallel circuit of proportional-integral-derivative controller (PID).

The fuel cell system can comprise different types of fuel cells, for example, fuel cells of the PEFC, DMFC or HT-PEFC types.

The objective is also achieved by an active hybrid system comprising a fuel cell system according to an exemplary embodiment of the present invention as well as an energy storage unit that is especially configured as a lead, NiMH, Li-ion or NiCd accumulator or as a supercap.

Moreover, exemplary embodiments of the present invention relate to a method for regulating a fuel cell voltage U_{FC,actual} in a fuel cell system, whereby the fuel cell system comprises a fuel cell, a DC/DC transformer that is coupled to the fuel cell and that can be coupled to an energy storage unit, as well as a control and regulation unit connected to the fuel cell and to the DC/DC transformer, and whereby the method comprises the following steps:
the control and regulation unit receives the controlled variable U_{FC,actual}, compares the controlled variable U_{FC,actual} to a predefined setpoint value U_{FC,setpoint} and determines a manipulated variable I_{DC/DC,setpoint} on this basis;
a minimum voltage value U_{FC,min} is determined;
U_{FC,setpoint} is selected in such a way that U_{FC,setpoint}>U_{FC,min};
the control and regulation unit relays the manipulated variable I_{DC/DC,setpoint} to the DC/DC transformer;
as a function of the manipulated variable I_{DC/DC,setpoint}, the DC/DC transformer applies the current I_{FC,actual} to the fuel cell.

The method may protect the fuel cell against excessive stress or premature ageing. This is achieved in that the fuel cell voltage U_{FC} does not fall below a minimum value U_{FC,min}.

In an exemplary embodiment of the method, it is provided that the minimum variable U_{FC,min}, as the limiting performance characteristics U_{FC,min}, is a function f of parameters, especially as the temperature-dependent (T_{FC}-dependent) limiting performance characteristics U_{FC,min}=f(T_{FC}), and it is stored in the control and regulation unit.

This takes into account the fact that the critical minimum value U_{FC,min} is substantially influenced by the temperature T_{FC}.

Another exemplary embodiment of the method provides that the minimum variable U_{FC,min}, as the limiting performance characteristics U_{FC,min}, is stored in the control and regulation unit as a function f of a fuel cell that has not aged. The performance characteristics of a fuel cell that has not aged are also referred to as the rated performance characteristics.

By taking the rated performance characteristics as the basis, one obtains U_{FC,min}=f as the limiting performance characteristics, and this yields useful values for relatively new fuel cells.

In an exemplary embodiment of the method, the control and regulation unit compares the controlled variable U_{FC,actual} to the predefined setpoint variable U_{FC,setpoint} and determines a manipulated variable I_{DC/DC,setpoint} on this basis. Here, it applies that U_{FC,setpoint}=U_{FC,min}.

In this manner, the minimum value U_{FC,min} becomes the setpoint value U_{FC,setpoint} for the regulation of the fuel cell voltage U_{FC}. This ensures that the fuel cell capacity is optimally utilized during operation without being overloaded.

The objective is also achieved by an exemplary method for regulating the performance characteristics of a fuel cell, comprising current/voltage characteristic curves of the fuel cell as a function of at least one operating variable, for example, T_{FC}, λₐᵢᵣ, encompassing the following steps:
determining initial values T₀, λ_{0 . . .} , of operating variables, for example, T_{FC}, λₐᵢᵣ, of the fuel cell;
measuring the voltage U_{FC,actual} and the current strength I_{FC,actual} of the fuel cell;
calculating a fictive current strength Iₜₕₑₒ from the measured voltage U_{FC,actual} and from an initial value T₀, λ₀ of the operating variable T_{FC}, λₐᵢᵣ;
comparing the measured current strength I_{FC,actual} to the fictive current strength Iₜₕₑₒ;
changing the operating variable T_{FC}, λₐᵢᵣ into a new initial value T₁, λ₁ so that I_{FC,actual}=Iₜₕₑₒ applies;
determining a new initial value T₁, λ₁, . . . of the operating variables, for example, T_{FC}, of the fuel cell.

In this manner, the performance characteristics of the fuel cell are adapted to the age-related decline of its output, and the output of the fuel cell can still be maintained, at least for a considerably prolonged period of operation, in spite of the onset of ageing.

An operating variable can be selected from the group of variables encompassing the temperature T_{FC}, air surplus λₐᵢᵣ, air volume flow d/dt Vₐᵢᵣ, fuel concentration, fuel mass flow d/dt operating pressure, fuel-, air-humidification or fuel circulation rates.

### BRIEF DESCRIPTION OF THE DRAWINGS

The invention will be explained below by way of an example, making reference to the drawings. These show the following:

FIG. 1 is a schematic depiction of a circuit of a fuel cell and an energy storage unit in an active hybrid system,

FIG. 2 is a schematic depiction of a regulation structure of a fuel cell system according to an exemplary embodiment of the present invention,

FIG. 3 is a flow chart showing a method for the regulation of the performance characteristics,

FIG. 4 is a flow chart showing a method for the regulation of the performance characteristics, with reference to the example of the surplus air as the operating variable.

### DETAILED DESCRIPTION OF SPECIFIC EMBODIMENTS

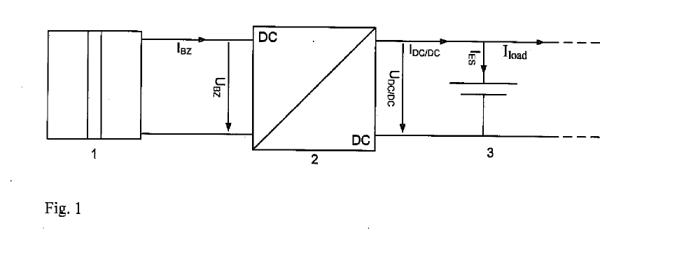

FIG. 1 shows a schematic depiction of a circuit of a fuel cell 1 and of an energy storage unit 3 in an active hybrid system. Between the fuel cell 1 and the energy storage unit 3, there is a DC/DC transformer 2, in which the output current I_{DC/DC} can be actively set. The control and regulation unit 4 (not shown here) prescribes a setpoint value I_{DC/DC,setpoint} for the current, and the DC/DC transformer 2 regulates it.

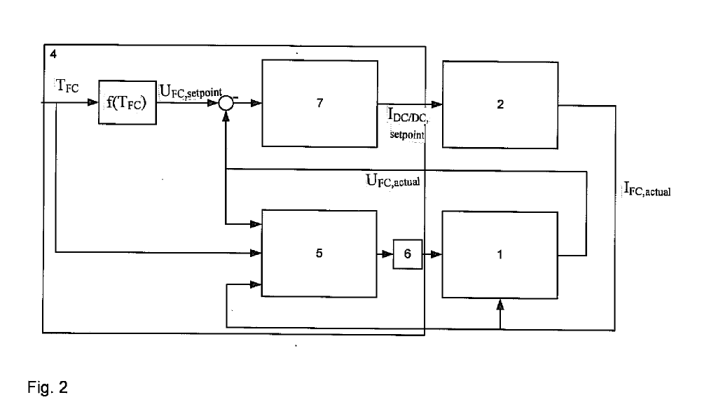

FIG. 2 shows a regulation structure of a fuel cell system according to an exemplary embodiment of the present invention. In this example, the minimum value U_{FC,min}, as the setpoint value U_{FC,setpoint}, is used for the fuel cell voltage. In this manner, an optimal utilization of the capacity of the fuel cell 1 is ensured during driving operation, without the fuel cell 1 being overloaded. A control and regulation unit 4 comprises a PID controller 7, a performance characteristic regulator 5 and a device 6 for controlling at least one operating variable. The PID controller 7 has the function of adjusting the fuel cell voltage U_{FC} to a setpoint value U_{FC,setpoint}. The current I_{DC/DC,setpoint} at the output of the DC/DC transformer 2 serves as the manipulated variable. The fuel cell current I_{FC,actual} that is established is the input parameter for the performance characteristic regulator 5 and for the fuel cell 1. If the current I_{FC,actual} is applied to the fuel cell 1, the value obtained as the output value is a momentary actual value U_{FC,actual} of the fuel cell voltage as a function of the operating variables, whereby the actual value U_{FC,actual} at the PID controller 7 is compared to the prescribed setpoint value U_{FC,setpoint}. In case of a control deviation I U_{FC,setpoint}−U_{FC,actual} I>0, the manipulated variable I_{DC/DC,setpoint} is corrected, and the control loop is once again executed.

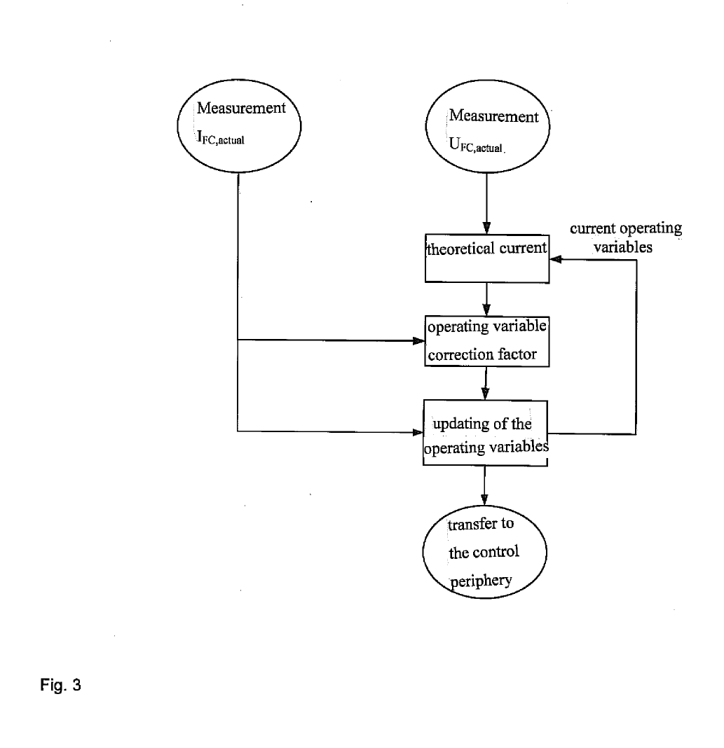

The function of the performance characteristic regulator 5 is to compensate for deviations of the fuel cell performance from the normal state by correcting operating variables. Thus, the performance characteristic regulator 5 is an advantageous element of the fuel cell system according to the invention. Here, first of all, the rated performance characteristics of a fuel cell 1 that has not aged is stored in the control and regulation unit 4. In this context, the performance characteristics comprise current/voltage performance characteristics of the fuel cell 1 as a function of operating variables. Inputs into the performance characteristic regulator 5 are the measured values for the stack voltage U_{FC,actual} and for the stack current I_{FC,actual}, i.e. the voltage U_{FC,actual} at the fuel cell stack and the current strength I_{FC,actual} at the fuel cell stack. The process that takes place here is shown in a generalized form in FIG. 3.

FIG. 3 shows a flow chart for the regulation of the performance characteristics. The momentarily measured values for the operating variables, including the momentarily measured values U_{FC,actual} for the stack voltage, go as information into the block “theoretical current”. An appertaining fictive current strength Iₜₕₑₒ is determined using the above-described performance characteristics. The block “operating variable correction factor” uses the deviation from the measured fuel cell current I_{FC,actual} and from the previously determined fictive current strength Iₜₕₑₒ to ascertain which operating variables are corrected and to what extent, in order to restore the envisaged normal state of the fuel cell performance once again. The block “updating the operating variables” calculates the new values of the operating variables and transmits them to the device 6 for controlling the periphery.

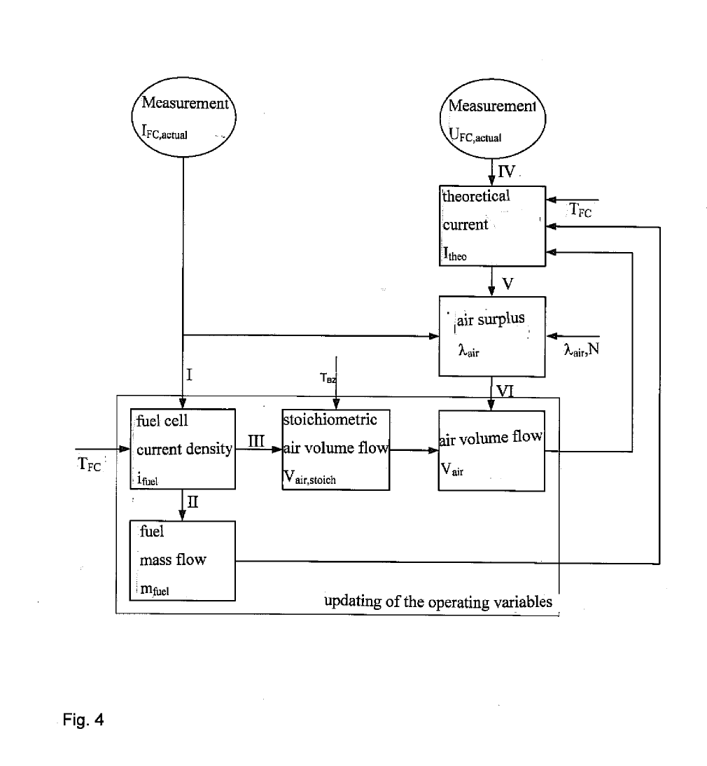

FIG. 4 shows a flow chart for the regulation of the performance characteristics, making reference to the example of the surplus air λₐᵢᵣ as the operating variable. Here, the operating variable surplus air λₐᵢᵣ is corrected for purposes of attaining the normal state of the fuel cell 1. For this purpose, the following steps are executed:
I. calculating the fuel current density i_{fuel}, taking (temperature-dependent) fuel losses into account,
II. calculating the fuel mass flow d/dt m_{fuel} using Faraday's law, and actuating the fuel supply unit, for example, by means of the gas control valve, a metering pump, etc.,
III. calculating the stoichiometric air volume flow d/dt V_{air,stoich},
IV. calculating the fictive stack current Iₜₕₑₒ as a function of the momentarily measured operating variables, using the stored performance characteristics,
V. comparing the measured stack current I_{FC,actual} to the fictive stack current Iₜₕₑₒ and changing the manipulated variable air surplus λₐᵢᵣ until the measured stack current I_{FC,actual} matches the fictive stack current Iₜₕₑₒ,
VI. calculating the air volume flow d/dt Vₐᵢᵣ.

### REFERENCE NUMERALS

1 fuel cell
2 DC/DC transformer
3 energy storage unit
4 control and regulation unit
5 performance characteristic regulator
6 device for controlling the operating variables
7 PID controller

1-5. (canceled)

6. A fuel cell system for mobile applications, comprising:
a fuel cell;
a DC/DC transformer that is coupled to the fuel cell and that can be coupled to an energy storage unit;
a control and regulation unit connected to the fuel cell and to the DC/DC transformer, the control and regulation unit being adapted to store performance characteristics of a fuel cell that has not aged;
a performance characteristic regulator associated with the control and regulation unit, the performance characteristic regulator being adapted to receive a value I_{FC,actual} of a current and to receive from the fuel cell a voltage value U_{FC,actual} as well as a value for at least one additional operating variable of the fuel cell system, the performance characteristic regulator being adapted to process the received values I_{FC,actual}, U_{FC,actual} and the value for the operating variable so as to create a control signal, and to relay the control signal to a device for controlling the operating variable.

7. The fuel cell system recited in claim 6, wherein the fuel cell comprises a fuel cell of the PEFC, DMFC or HT-PEFC type.

8. The fuel cell system recited in claim 6, wherein the energy storage unit is configured as a lead, NiMH, Li-ion or NiCd accumulator or as a supercap.

9. A method for regulating the performance characteristics of a fuel cell system, or an active hybrid system, comprising current/voltage characteristic curves of the fuel cell as a function of at least one operating variable (T_{FC}, λₐᵢᵣ), the method comprising:
determining initial values T₀, λ₀ of operating variables (T_{FC}, λₐᵢᵣ) of the fuel cell;
measuring the voltage U_{FC,actual} and the current strength I_{FC,actual} of the fuel cell;
calculating a fictive current strength (Iₜₕₑₒ) from the measured voltage U_{FC,actual} and from an initial value (T₀, λ₀) of the operating variable T_{FC}, λₐᵢᵣ;
comparing the measured current strength I_{FC,actual} to the fictive current strength Iₜₕₑₒ;
changing the operating variable (T_{FC}, λₐᵢᵣ) into a new initial value (T₁, λ₁) so that I_{FC,actual}=Iₜₕₑₒ applies;
determining a new initial value (T₁, λ₁) of the operating variables (T_{FC}, λₐᵢᵣ) of the fuel cell.

10. The method recited in claim 9, comprising selecting an operating variable from the group of variables encompassing the temperature T_{FC}, air surplus λₐᵢᵣ, air volume flow d/dt Vₐᵢᵣ, fuel concentration, fuel mass flow d/dt m_{fuel}, operating pressure, fuel-, air-humidification or fuel circulation rates.

11. A system for regulating the performance characteristics of a fuel cell system, or an active hybrid system, comprising current/voltage characteristic curves of the fuel cell as a function of at least one operating variable (T_{FC}, λₐᵢᵣ), the system comprising:
means for determining initial values T₀, λ₀ of operating variables (T_{FC}, λₐᵢᵣ) of the fuel cell;
means for measuring the voltage U_{FC,actual} and the current strength I_{FC,actual} of the fuel cell;
means for calculating a fictive current strength (Iₜₕₑₒ) from the measured voltage U_{FC,actual} and from an initial value (T₀, λ₀) of the operating variable T_{FC}, λₐᵢᵣ;
means for comparing the measured current strength I_{FC,actual} to the fictive current strength Iₜₕₑₒ;
means for changing the operating variable (T_{FC}, λₐᵢᵣ) into a new initial value (T₁, λ₁) so that I_{FC,actual}=Iₜₕₑₒ applies;
means for determining a new initial value (T₁, λ₁) of the operating variables (T_{FC}, λₐᵢᵣ) of the fuel cell.
